(19) United States
(12) Patent Application Publication
(10) Pub. No.: US 2013/0124158 A1
(43) Pub. Date: May 16, 2013

(54) MODEL CONSTRUCTION APPARATUS AND MODEL CONSTRUCTION METHOD

(71) Applicants: Hayato Nakada, Minamitsuru-gun (JP); Akira Ohata, Mishima-shi (JP)

(72) Inventors: Hayato Nakada, Minamitsuru-gun (JP); Akira Ohata, Mishima-shi (JP)

(21) Appl. No.: 13/812,018

(22) PCT Filed: Jul. 28, 2011
(86) PCT No.: PCT/IB2011/001989

§ 371 Date: Jan. 24, 2013

(30) Foreign Application Priority Data
Jul. 30, 2010 (JP) 2010-172581

(51) Int. Cl. G06F 17/50

(52) U.S. Cl. CPC G06F 17/5004
USPC 703/1

(57) ABSTRACT

The invention relates to a model construction apparatus which constructs a model of a plant that includes a plurality of modeling objects, and which has a graphical user interface. The model construction apparatus has: a function of constructing models of the modeling objects separately for each modeling object as object models; a function of constructing the plant model by connecting the object models with each other by connection lines so that conserved quantities output from the object models are able to be exchanged between related object models that are included among the object models; a function of constructing elements that correspond to the object models as modeling object elements on the graphical user interface; and a function of storing the object models while associating the object models with the respective modeling object elements corresponding to the object models so that the object models are able to be invoked via the modeling object elements.

### BACKGROUND OF THE INVENTION

1. Field of the Invention

The invention relates to a model construction apparatus and a model construction method.

2. Description of Related Art

Japanese Patent Application Publication No. 2010-513787 (JP-A-2010-513787) describes a simulation method for operations of an engine. In this simulation method, an engine model simplified from a complete engine model (which will hereinafter be termed “simple engine model”) is constructed. It is to be noted herein that a modeling tool for use in this simulation method has a graphical user interface (hereinafter, referred to as “GUI”). Then, a user of this modeling tool is allowed to prescribe a model by using basic component elements of an engine (e.g., a duct, a manifold, a cylinder, or a turbocharger) via the GUI. Besides, the modeling tool user is allowed to input parameters regarding the engine for which a simulation is to be performed (e.g., an amount of fuel injection, an engine rotation speed) via the GUI. Besides, the modeling tool user is allowed to construct a simple engine model via the GUI.

By the way, the simple engine model that is constructed by a simulation method described in Japanese Patent Application Publication No. 2010-513787 (JP-A-2010-513787) is a model of a whole engine that includes a plurality of component elements. Therefore, in the case where the characteristic of a component element changes over time, or where a component element is replaced with another component element, or where a new component element is added to the engine, a desired simple engine model cannot be obtained unless a complete engine model is newly constructed and a simple engine model is newly constructed from the newly constructed complete engine model.

That is, the simple engine model that is constructed by the simulation method described in Japanese Patent Application Publication No. 2010-513787 (JP-A-2010-513787) is not structured so. that a portion that corresponds to a model of a given component element can be specifically determined. Therefore, even in the case where only one or few of the component elements of the engine are altered, a desired simple engine model cannot be obtained unless the whole of a simple engine model is newly constructed.

In the case where a desired simple engine model is obtained by newly constructing the whole of a simple engine model, the labor needed for obtaining a desired simple engine model is greater than in the case where a desired simple engine model is obtained by modifying only a portion of the simple engine model that has already been constructed.

Of course, in the simulation method described in Japanese Patent Application Publication No. 2010-513787 (JP-A-2010-513787), there is a possibility of a reduction of the labor needed for obtaining a desired simple engine model, if an, existing simple engine model can be referred to when a simple engine model is newly constructed. However, since the simple engine model is not structured so that a portion that corresponds to a model of a given component element cannot be specifically determined, even a change in only one or more of the component elements of the engine requires new construction of the whole of a simple engine model in order to obtain a desired simple engine model.

Therefore, even if the existing simple engine model can be referred to when a simple engine model is to be newly constructed, the labor needed for obtaining a desired simple engine model is still great.

In the case where there already exists a model of a plant (e.g., an engine described in Japanese Patent Application Publication No. 2010-513787 (JP-A-2010-513787) (the model will hereinafter be referred to as “plant model”) that includes a plurality of objects to be modeled (e.g., objects corresponding to component elements described in Japanese Patent Application Publication No. 2010-513787 (JP-A-2010-513787), which will hereinafter be referred to as “modeling objects”) regardless of whether or not the objects are objects to be controlled, the foregoing problem arises also in the case where a plant model is to be newly constructed when the characteristic of a modeling object has changed over time, or when a modeling object has been replaced with another modeling object, or when a new modeling object has been added to the plant.

That is, in the case where there exists an already constructed plant model (hereinafter, referred to as “existing plant model”), when the characteristic of a modeling object has changed over time, or when a modeling, object has been replaced with another modeling object, or when a new modeling object has been added to the plant, less labor will be needed for acquiring a desired plant model if a desired plant model is acquired by modifying only a portion of the existing plant model that needs to be modified than if a whole plant model is newly constructed independently of the existing plant model, provided that the portion of the existing plant model that needs to be modified can be easily specifically determined.

### SUMMARY OF THE INVENTION

The invention provides a model construction apparatus and a model construction method that are capable of constructing a plant model that allows specific determination of a portion that corresponds to a model of a specific modeling object, when a model of a plant that includes a plurality of modeling objects is to be constructed.

A first aspect of the invention relates to a model construction apparatus which constructs a model of a plant that includes a plurality of modeling objects as a plant model, and which has a graphical user interface.

The model construction apparatus has a function of constructing models of the modeling objects separately for each modeling object as object models, a function of constructing the plant model by connecting the object models with each other by connection lines so that conserved quantities output from the object models are able to be exchanged between related object models that are included among the object models, a function of constructing elements that correspond to the object models as modeling object elements on the graphical user interface, and a function of storing the object models while associating the object models with the respective modeling object elements corresponding to the object models so that the object models are able to be invoked via the modeling object elements.

In the invention, a plant model can be constructed by constructing object models separately for individual modeling objects, and by connecting the object models to each other by connection lines so that the conserved quantities output from the object models are able to be exchanged between related object models that are included among the object models. Then, the object models can be stored in association with their corresponding modeling object elements so that each object model can be invoked via the modeling object elements that are constructed on the graphical user interface in correspondence to the individual object models. Therefore, the object model that corresponds to a specific modeling object can be specifically determined through the use of its corresponding modeling object element.

According to the invention, for example, in the case where there arises a need to newly construct the plant model because the characteristic of a modeling object has changed over time, the object model of the modeling object whose characteristic has changed can be specifically determined via the modeling object element that corresponds to the modeling object whose characteristic has changed. Therefore, in this case, in order to newly construct a plant model, the object model of the modeling object whose characteristic has changed can be invoked via the modeling object element that corresponds to the modeling object whose characteristic has changed, and an object model of the modeling object whose characteristic has changed can be newly constructed by appropriately modifying the invoked object model, and then a plant model can be newly constructed by connecting the newly constructed object model to the other existing object models by the existing connection lines that correspond to the modeling object whose characteristic has changed. Specifically, according to this apparatus, a plant model can be newly constructed, not by newly constructing a plant model through modification of the entire plant model, but by modifying an existing object model that is a portion of the plant model (in other words, by replacing the existing object model that is a portion of the plant model, with a newly constructed object model). Therefore, a plant model can be newly constructed with a small amount of labor.

Besides, for example, in the case where there arises a need to newly construct the plant model because an existing modeling object is replaced with a new modeling object that has substantially the same characteristic as the existing modeling object, the object model of the pre-replacement modeling object can be specifically determined via the modeling object element that corresponds to the pre-replacement modeling object. Therefore, in this case, a plant model can be newly constructed by invoking the object model of the pre-replacement modeling object via the modeling object element that corresponds to the re-replacement modeling object, and newly constructing an object model of the post-replacement modeling object by appropriately modifying the invoked object model, and then connecting the newly constructed object model to the other existing object models by the existing connection lines that correspond to the pre-replacement modeling object. That is, according to this apparatus, a plant model is not newly constructed by modifying the whole plant model, but a plant model can be newly constructed by modifying an existing object model that is a portion of the plant model (in other words, by replacing an existing object model that is a portion of the plant model with a newly constructed object model). Therefore, a plant model can be newly constructed with a small amount of labor.

Besides, for example, in the case where there arises a need to newly construct the plant model because a new modeling object that has substantially the same characteristic as an existing modeling object is added to a plant, the object model of the existing modeling object can be specifically determined via the modeling object element that corresponds to the existing modeling object that has substantially the same characteristic as the added new modeling object. Therefore, in this case, a plant model can be newly constructed by invoking the object model of the existing modeling object via the modeling object element that corresponds to the existing modeling object that has substantially the same characteristic as the added new modeling object, and newly constructing an object model of the added new modeling object by appropriately modifying the invoked object model, and then, connecting the newly constructed object model to related existing object models by new connection lines so that the conserved quantity output from the newly constructed object model can be sent to the related existing object models. That is, according to this apparatus, a plant model is not newly constructed by modifying the whole plant model, but a plant model can be newly constructed by adding a newly constructed object model to the existing plant model. Therefore, a plant model can be newly constructed with a small amount of labor.

Besides, for example, in the case where there arises a need to newly construct because a new modeling object that has a characteristic different from that of an existing modeling object is added to a plant, a plant model can be newly constructed by newly constructing an object model of the added new modeling object, and connecting the newly constructed object model to related existing object models by new connection lines so that the conserved quantity output from the newly constructed object model can be sent to the related existing object models. That is, according to this apparatus, a plant model is not newly constructed by modifying the whole plant model, but a plant model can be newly constructed by adding a newly constructed object model to the existing plant model. Therefore, a plant model can be newly constructed with a small amount of labor.

Besides, the model construction apparatus may have a function of utilizing as an object model a model of a modeling object that is derived from a differential algebraic equation that is based on a physical law if the plant is capable of being expressed by a plurality of physical laws.

According to the foregoing differential algebraic equation, each modeling object is accurately modeled, so that important factors in the physical laws can be expressed. The model derived by a differential algebraic equation that is based on the physical laws can be utilized as an object model. Therefore, an object model in which a factor in an important physical law is taken into account can be constructed, so that a plant model in which a factor in an important physical law can be constructed as a plant model.

The model construction apparatus may further have: a function of utilizing as an initial object model the model of the modeling object that is derived from the differential algebraic equation based on the physical law; a function of constructing a simple object model by simplifying the initial object model; and a function of utilizing the simple object model as the object model.

With this arrangement, the model construction apparatus is able to construct simple object models by simplifying the initial object models derived separately for the modeling objects and to utilize the constructed simple object models as object models. That is, the plant model can be constructed as a simplified model, by simple models that are constructed by simplifying the models derived separately for the individual modeling objects. Since the simplification of models is performed with respect to the models for the individual modeling objects, simplified models in which redundancy has been eliminated can be constructed with a small amount of labor.

A second aspect of the invention relates to a model construction method that constructs a model of a plant that includes a plurality of modeling objects as a plant model.

In the invention, the model construction method includes: constructing models of the modeling objects separately for each modeling object as object models;

constructing the plant model by connecting the object models by connection lines so that conserved quantities output from the object models are able to be exchanged between related object models; constructing elements that correspond to the object models as modeling object elements on the graphical user interface; and storing the object models while associating the object models with the respective modeling object elements corresponding to the object models so that the object models are able to be invoked via the modeling object elements.

For the same reason as that stated above in conjunction with the model construction apparatus of the invention, the object model that corresponds to a specific modeling object can be specifically determined via a modeling object element.

If the plant is capable of being expressed by a plurality of physical laws, a model of a modeling object that is derived from a differential algebraic equation based on a physical law is utilized as an object model.

For the same reason as that stated above in conjunction with the model construction apparatus of the invention, an object model in which a factor in an important physical law has been taken into account can be constructed, and therefore a plant model in which a factor in an important physical law has been taken into account can be constructed.

A model of a modeling object that is derived from a differential algebraic equation based on a physical law may be utilized as an initial object model, and a simple object model may be constructed by simplifying the initial object model, and the simple object model may be utilized as the object model.

For the same reason as that stated above in conjunction with the model construction apparatus of the invention, a simplified mode in which redundancy has been eliminated can be constructed with a small amount of labor.

When there arises a need to newly construct the plant model because a characteristic of a modeling object has changed, the object model that corresponds to the modeling object whose characteristic has changed may be invoked via a modeling object element that corresponds to the modeling object whose characteristic has changed, and the object model of the modeling object whose characteristic has changed may be newly constructed by utilizing the invoked object model, and the plant model may be constructed by connecting the newly constructed object model to at least one other existing object model by an existing connection line that corresponds to the modeling object whose characteristic has changed, and the newly constructed object model may be stored and associated with an existing modeling object element that corresponds to the modeling object whose characteristic has changed.

When there arises a need to newly construct the plant model because a modeling object is replaced with another modeling object, the object model that corresponds to a pre-replacement modeling object may be invoked via the modeling object element that corresponds to the pre-replacement modeling object, and the object model of a post-replacement modeling object may be newly constructed by utilizing the invoked object model, and the plant model may be constructed by connecting the newly constructed object model to at least one other existing object model by an existing connection line that corresponds to the pre-replacement modeling object, and the newly constructed object model may be stored and associated with the existing modeling object element that corresponds to the pre-replacement modeling object.

When there arises a need to newly construct the plant model because a new modeling object having substantially same characteristic as an existing modeling object is added to plant, the object model of an existing modeling object that has substantially same characteristic as the added new modeling object may be invoked via the modeling object element that corresponds to the existing modeling object, and the object model of the added new modeling object may be newly constructed by utilizing the invoked object model, and the plant model may be constructed by connecting the newly constructed object model to a related existing object model by a new connection line so that the conserved quantity output from the newly constructed object model is able to be sent to the related existing object model, and the modeling object element that corresponds to the newly constructed object model may be newly constructed on the graphical user interface, and the newly constructed object model may be stored and associated with the newly constructed modeling object element so that the newly constructed object model is able to be invoked via the newly constructed modeling object element.

When there arises a need to newly construct the plant model because a new modeling object that has a characteristic different from the characteristic of an existing modeling object is added to the plant, the object model of the added new modeling object may be newly constructed, and the plant model may be constructed by connecting the newly constructed object model to a related existing object model by a new connection line so that the conserved quantity output from the newly constructed object model is able to be sent to the related existing object model, and the modeling object element that corresponds to the newly constructed object model may be newly constructed on the graphical userinterface, and the newly constructed object model may be stored and associated with the newly constructed modeling object element so that the newly constructed object model is able to be invoked via the newly constructed modeling object element.

According to the invention, in the case where there arises a need to newly construct a plant model because the characteristic of a modeling object has changed over time, or the case where there arises a need to newly construct a plant model because a modeling object is replaced with another modeling object, or the case where there arises a need to newly construct a plant model because a new modeling object that has substantially the same characteristic as an existing modeling object is added to a plant, or the case where there arises a need to newly construct a plant model because a new modeling object that has a characteristic different from the characteristic of an existing modeling object, a plant model is not newly constructed by modifying the whole plant model, but a plant model is newly constructed by modifying an existing object model that is a portion of the plant model (in other words, by replacing an existing object model that is a portion of the plant model with the newly constructed object model), as described above in conjunction with the model construction apparatus. Therefore, a plant model can be newly constructed with a small amount of labor.

Initial object models that correspond to the object models may be stored and associated with respective modeling object elements that correspond to the object models that correspond to the initial object models so that the initial object models are able to be invoked via the respective modeling object elements that correspond to the object models.

When there arises a need to newly construct the plant model because a characteristic of a modeling object has changed, the initial object model that corresponds to the modeling object whose characteristic has changed may be invoked via a modeling object element that corresponds to the modeling object whose characteristic has changed, and the initial object model of the modeling object whose characteristic has changed may be newly constructed by utilizing the invoked initial object model, and the simple object model may be newly constructed by simplifying the newly constructed initial object model, and the plant model may be constructed by connecting the newly constructed simple object model to at least one other existing simple object model by an existing connection line that corresponds to the modeling object whose characteristic has changed, and the newly constructed initial object model may be stored and associated with an existing modeling object element that corresponds to the modeling object whose characteristic has changed.

When there arises a need to newly construct the plant model because a modeling object is replaced with another modeling object, the initial object model that corresponds to a pre-replacement modeling object may be invoked via the modeling object element that corresponds to the pre-replacement modeling object, and the initial object model of a post-replacement modeling object may be newly constructed by utilizing the invoked initial object model, and the plant model may be constructed by newly constructing the simple object model through simplification of the newly constructed initial object model, and by connecting the newly constructed simple object model to at least one other existing simple object model by an existing connection line that corresponds to the pre-replacement modeling object, and the newly constructed initial object model may be stored and associated with the existing modeling object element that corresponds to the pre-replacement modeling object.

When there arises a need to newly construct the plant model because a new modeling object that has substantially same characteristic as an existing modeling object is added to the plant, the initial object model of an existing modeling object that has substantially same characteristic as the added new modeling object may be invoked via the modeling object element that corresponds to the existing modeling object, and the initial object model of the added new modeling object may be newly constructed by utilizing the invoked initial object model, and the simple object model may be newly constructed by simplifying the newly constructed initial object model, and the plant model may be constructed by connecting the newly constructed simple object model to a related existing simple object model by a new connection line so that the conserved quantity output from the newly constructed simple object model is able to be sent to the related existing simple object model, and the modeling object element that corresponds to the newly constructed initial object model may be newly constructed on the graphical user interface, and the newly constructed initial object model may be stored and associated with the newly constructed modeling object element so that the newly constructed initial object model is able to be invoked via the newly constructed modeling object element.

When there arises a need to newly construct the plant model because a new modeling object that has a characteristic different from the characteristic of an existing modeling object is added to the plant, the simple object model may be newly constructed by newly constructing the initial object model of the added new modeling object and by simplifying the newly constructed initial object model, and the plant model may be constructed by connecting the newly constructed simple object model to a related existing simple object model by a new connection line so that the conserved quantity output from the newly constructed simple object model is able to be sent to the related existing simple object model, and the modeling object element that corresponds to the newly constructed initial object model may be newly constructed on the graphical user interface, and the newly constructed initial object model may be stored and associated with the newly constructed modeling object element so that the newly constructed initial object model is able to be invoked via the newly constructed modeling object element.

According to the invention, in the case where there arises a need to newly construct a plant model because the characteristic of a modeling object has changed over time, the initial object model of the modeling object whose characteristic has changed is specifically determined via the modeling object element that corresponds to the modeling object whose characteristic has changed. Therefore, according to the invention, when a plant model is to be newly constructed, the initial object model of the modeling object whose characteristic has changed can be invoked via the modeling object element that corresponds to the modeling object whose characteristic has changed, and the initial object model of the modeling object whose characteristic has changed can be newly constructed by appropriately modifying the invoked initial object model, and a simple object model can be constructed by simplifying the newly constructed initial object model, and then a plant model can be newly constructed by connecting the newly constructed simple object model to other existing simple object models by the existing connection lines that correspond to the modeling object whose characteristic has changed. That is, according to this model construction method, a plant model is not newly constructed by modifying the whole plant model, but a plant model is newly constructed by modifying the initial object model that corresponds to the existing simple object model that is a portion of the plant model, and constructing a simple object model from the modified initial object model, and replacing the existing simple object model that is a portion of the plant model with the newly constructed simple object model. Therefore, a plant model can be newly constructed with a small amount of labor.

Besides, in the case where there arises a need to newly construct a plant model because an existing modeling object is replaced with a new modeling object that has substantially the same characteristic as the existing modeling object, the initial object model of the pre-replacement modeling object is specifically determined via the modeling object element that corresponds to the pre-replacement modeling object. Therefore, in the invention, when a plant model is to be newly constructed in the foregoing case, the initial object model of the pre-replacement modeling object can be invoked via the modeling object element that corresponds to the pre-replacement modeling object, and an initial object model of the post-replacement modeling object can be newly constructed by appropriately modifying the invoked initial object model, and a simple object model can be constructed by simplifying the newly constructed initial object model, and then a plant model can be newly constructed by connecting the newly constructed simple object model to other existing simple object models by the existing connection lines that correspond to the pre-replacement modeling object. That is, according to this mode construction method, a plant model is not newly constructed by modifying the whole plant model, but a plant model is newly constructed by modifying the initial object model that corresponds to the existing simple object model that is a portion of the plant model, and constructing a simple object model from the modified initial object model, and replacing the existing simple object model that is a portion of the plant model with the newly constructed simple object model. Therefore, a plant model can be newly constructed with a small amount of labor.

Besides, in the case where there arises a need to newly construct a plant model because a new modeling object that has substantially the same characteristic as an existing modeling object is added to a plant, the initial object model of the existing modeling object is specifically determined via the modeling object element that corresponds to the existing modeling object that has substantially the same characteristic as the added new modeling object. Therefore, in the invention, when a plant model is to be newly constructed, the initial object model of the existing modeling object can be invoked via the modeling object element that corresponds to the existing modeling object that has substantially the same characteristic as the added new modeling object, and an initial object model of the added new modeling object can be newly constructed by appropriately modifying the invoked initial object model, and a simple object model can be constructed by simplifying the newly constructed initial object model, and then a plant model can be newly constructed by connecting the newly constructed simple object model to related existing simple object models by newly connection lines so that the conserved quantity output from the newly constructed simple object model can be sent to the related existing simple object models. That is, according to this model construction method, a plant model is not newly constructed by modifying the whole plant model, but a plant model is newly constructed by adding the newly constructed simple object model to the existing plant model. Therefore, a plant model can be newly constructed with a small amount of labor.

Besides, in the case where there arises a need to newly construct a plant model because a new modeling object that have a characteristic different from the characteristic of an existing modeling object is added to a plant, an initial object model of the added new modeling object can be newly constructed, and a simple object model can be constructed by simplifying the newly constructed initial object model, and then a plant model can be newly constructed by connecting the newly constructed simple object model to related existing simple object models by new connection lines so that the conserved quantity output from the newly constructed simple object model can be sent to the related existing simple object models. That is, according to this model construction method, a plant model is not newly constructed by modifying the whole plant model, but a plant model is newly constructed by adding the newly constructed simple object model to the existing plant model. Therefore, a plant model can be newly constructed with a small amount of labor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing relationships between a plant model and simple object models in an embodiment of the invention;

FIG. 2 is a diagram showing relationships among graphical user interface elements (GUI elements), initial differential algebraic equations (initial DAEs) and simple differential algebraic equations (simple DAEs);

FIG. 3 is a diagram showing relationships between a plant model and simple object models in another embodiment of the invention;

FIG. 4 is a diagram showing relationships among graphical user interface elements (GUI elements) in an embodiment of the invention; and

FIG. 5 is a diagram showing relationships among simple differential algebraic equations (simple DAEs) in an embodiment of the invention.

### DETAILED DESCRIPTION OF EMBODIMENTS

A model construction apparatus in accordance with an embodiment of the invention constructs a model of a plant that includes a plurality of objects that need to be modeled (hereinafter, referred to as “modeling objects”), irrespective of whether or not an object needs to be controlled (hereinafter (hereinafter, a model of a plant will be referred to as “plant model).

For example, in the case where the plant is an internal combustion engine, the plant model is a model of the internal combustion engine, and the modeling objects are, for example, fuel injection valves that supply fuel into combustion chambers, a throttle valve disposed in an intake passageway in order to control the amount of gas that is taken into the combustion chambers, a supercharger that is capable of raising and lowering the pressure of the gas taken into the combustion chambers and that is equipped with vanes for controlling the degree of rise or fall of the pressure of the gas, an exhaust gas recirculation device that introduces, into the intake passageway, exhaust gas discharged from the combustion chambers into an exhaust passageway and that has an exhaust gas recirculation control valve for controlling the amount of exhaust gas introduced into the intake passageway, etc.

Besides, the plant whose plant model is constructed by the model construction apparatus of this embodiment is a plant in which a plurality of physical laws hold. The physical laws herein include, for example, the momentum conservation law, the energy conservation law, the first law of thermodynamics, the Boyle-Charles law, etc.

In general, the plant model is used, for example, to calculate a conserved quantity of a plant when a certain quantity of manipulation is input to each modeling object, and to determine a quantity of manipulation that is needed in order to make the conserved quantity of the plant equal a target conserved quantity, on the basis of the calculated conserved quantity.

For example, in the case where the plant is an internal combustion engine, the amount of conservation is, for example, the amount of fuel supplied from a fuel injection valve to a combustion chamber, the amount of gas taken into the combustion chamber which is controlled by the throttle valve, the pressure of the gas taken into the combustion chamber that is controlled by the supercharger, the amount of exhaust gas introduced into the intake passageway which is controlled by an exhaust gas recirculation apparatus, etc.

Next, a plant model constructed by the model construction apparatus of the embodiment will be described in detail. The model construction apparatus of the embodiment constructs a model separately for each modeling object (hereinafter, referred to as “object model”). Then, each object model is a model obtained by simplifying, through a mathematical process, a model in which physical laws related to a corresponding modeling object are minutely expressed by differential algebraic equations (hereinafter, referred to as “initial object model”) (hereinafter, the thus-simplified model will be referred to as “simple object model”). Hereinafter, in the model construction apparatus of this embodiment, when an initial object model is to be constructed, a “physical model that satisfies conservation laws” which is targeted for related conserved quantitates, for example, mass, energy, kinetic momentum, numbers of molecules, etc., is utilized. Besides, the “model simplified by a mathematical process” means, for example, a model that is low in the degree, and that has a small number of adjustment parameters for use, and that performs a small number of computations, and that has a small size of program codes for execution of computation by the model.

Then, as shown in FIG. 1, each simple object model 10 is connected by connection lines 11 to one or more other simple object models 10 that correspond to one or more modeling objects that are related to the conserved quantity of the modeling object that corresponds to the simple object model 10. Then, the mutually connected simple object models 10 exchange with each other information (in other words, signal flows) regarding the conserved quantities which are calculated by the simple object models 10 and are output therefrom.

The model construction apparatus of this embodiment has a function of comparing the conserved quantities obtained from the individual simple object models when predetermined quantities of manipulation are input to variables in the simple object models and the conserved quantity obtained from the plant model at that time (hereinafter, the conserved quantity will be referred to as “theoretical conserved quantity”) with the conserved quantities of the individual modeling objects and the conserved quantity of the plant which are obtained when the same predetermined quantities of manipulation are actually input to the modeling objects (hereinafter, the conserved quantity will be referred to as “actual conserved quantity”).

Then, the model construction apparatus of this embodiment has a function of finding a parameter present in a simple object model so that the theoretical conserved quantity becomes equal to the actual conserved quantity. That is, the model construction apparatus of this embodiment has a function of identifying a parameter present in a simple object model on the basis of the actual conserved quantity. Then, the model construction apparatus of this embodiment has a function of constructing a plant model by adopting the identified parameter as a parameter present in a simple object model.

Besides, the model construction apparatus of this embodiment has a graphical user interface (hereinafter, referred to as “GUI”). Then, the model construction apparatus of this embodiment has a function of constructing, on the GUI, elements that correspond to the individual object models, and a function of storing the corresponding initial object models and simple object models in association with the elements constructed on the GUI (hereinafter, referred to as “GUI elements”).

Besides, a plant model constructed by the model construction apparatus of this embodiment is used, for example, to calculate the conserved quantity of each modeling object or the conserved quantity of the plant that are obtained when certain quantities of manipulation are input to the individual modeling objects (hereinafter, the quantities of manipulation will be referred to as “modeling object manipulation quantity”) and to determine a modeling object manipulation quantity that can cause the conserved quantities of the individual modeling objects or the conserved quantity of the plant to equal to a target conserved quantity, on the basis of the calculated conserved quantity.

For example, in the case where the plant model constructed by the model construction apparatus of this embodiment is used to determine modeling object manipulation quantities that are input to the modeling objects of an internal combustion engine, the plant model determines an optimum open valve duration of a fuel injection valve, the opening degree of the throttle valve, the opening degree of the vanes of the supercharger, or the opening degree of an exhaust gas recirculation control valve of the exhaust gas recirculation apparatus, according to the state of operation of the internal combustion engine, and creates maps or tables that store therein the open valve duration of the fuel injection valves, the opening degree of the throttle valve, the opening degree of the vanes, and the opening degree of the exhaust gas recirculation control valve that are determined according to the state of operation of the internal combustion engine.

By the way, for example, in the case where one of the modeling objects of a plant has changed after a long time of use of the plant, even if the modeling object manipulation quantities set through the use of the plant model constructed on the basis of the modeling objects prior to the change of the characteristic are input to the modeling objects, the conserved quantity of the modeling object whose characteristic has changed (hereinafter, referred to as “modeling object having a change in characteristic”) is not controlled to a target conserved quantity, or does not equal the conserved quantity that is calculated by the simple object model that corresponds to the modeling object having the change in characteristic (hereinafter, this conserved quantity will be referred to as “initial conserved quantity”). Besides, in the case where the characteristics of the other modeling object may not change but the conserved quantities of the other modeling objects (hereinafter, referred to as “modeling objects having no change in characteristic”) are affected by the conserved quantities of the modeling objects with change in characteristic, the conserved quantities of the modeling objects having no change in characteristic are not controlled a target conserved quantity, or do not equal predetermined conserved quantities, so that the conserved quantity of the plant is not controlled to a target conserved quantity, or does not equal a conserved quantity that is calculated by the plant model (hereinafter, referred to also as “predetermined conserved quantity”). Therefore, in the case where the characteristic of at least one of the modeling objects has changed, it is necessary to newly construct a plant model that has already been constructed (hereinafter, referred to as “existing plant model”) (in other words, it is necessary to reconstruct or modify the existing plant model) in order to secure a state in which the conserved quantities of the modeling objects and the conserved quantity of the plant model are controlled to target conserved quantities, or are equal to predetermined conserved quantities.

Besides, in the case where one of the modeling objects of a plant is replaced with a new modeling object that has a characteristic different from the characteristic of that modeling object, or the case where a new modeling object is added to the plant, it is also necessary to reconstruct or modify the existing plant model.

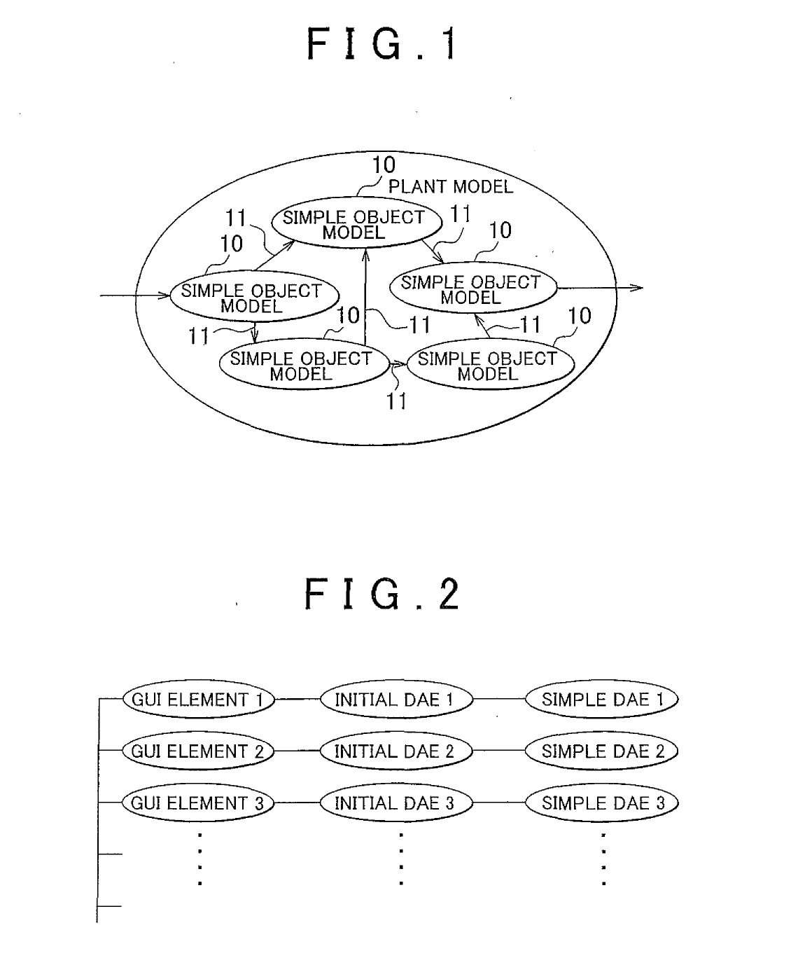

When the initial object models are simplified in order to construct the simple object models, the relationships between the initial object models and their corresponding GUI elements are lost. However, as described above, in this embodiment, the initial object models that are expressed by differential algebraic equations separately for the individual modeling objects are constructed, and simple object models are constructed by differential algebraic equations that are simplified through the simplification of the initial object models performed by the mathematical processing, and then the initial object models and the simple object models are stored in the memory in association with their corresponding GUI elements. That is, as shown in FIG. 2, the GUI elements, their corresponding initial differential algebraic equations (in other words, initial object models) and their corresponding simple differential algebraic equations (in other words, simple object models) are associated together and stored in the memory.

Therefore, in the model construction apparatus of this embodiment, in the case where one of the modeling objects has changed over time, the initial object model of the modeling object whose characteristic has changed can be specifically determined via the GUI element that corresponds to the modeling object whose characteristic has changed. Therefore, when a plant model is to be newly constructed by the model construction apparatus of this embodiment in the case where the characteristic of a modeling object has changed over time, the initial object model of the modeling object whose characteristic has changed is invoked (or reproduced) via the GUI element that corresponds to the modeling object whose characteristic has changed. By modifying the invoked initial object model, the initial object model of the modeling object whose characteristic has changed is newly constructed. A parameter of the newly constructed initial object model is identified. The foregoing newly constructed initial object model to which the identified parameter has been applied is simplified by a mathematical process, so as to construct a simple object model. Then, a plant model can be newly constructed by connecting the newly constructed simple object model to other existing simple object models by the existing connection lines that correspond to the modeling object whose characteristic has changed. That is, a plant model can be newly constructed by replacing the existing simple object model of the modeling object whose characteristic has changed, with the newly constructed simple object model. Therefore, this apparatus modifies the initial object model that corresponds to an existing simple object model that is a portion of the existing plant model, instead of newly constructing a plant model by modifying the whole existing plant model. A simple object model is constructed from the modified initial object model. A plant model can be newly constructed by replacing an existing simple object model that is a portion of the plant model with a newly constructed object model. Therefore, a plant model can be newly constructed with a small amount of labor.

Incidentally, as described above, the newly constructed initial object model and the newly constructed simple object model are stored in the memory, in association with their corresponding existing GUI element.

Besides, in the model construction apparatus of this embodiment, in the case where a model object is replaced with another modeling object, the initial object model of the pre-replacement modeling object can be specifically determined via the GUI element that corresponds to the pre-replacement modeling object. Therefore, when a plant model is to be newly constructed by the model construction apparatus of the embodiment in the case where a modeling object is replaced with a new modeling object and where the characteristic of the post-replacement modeling object is substantially the same of that of the pre-replacement modeling object, the initial object model of the pre-replacement modeling object is invoked (or reproduced) via the GUI element that corresponds to the pre-replacement modeling object. By modifying the invoked initial object model, an initial object model of the post-replacement modeling object is newly constructed. Then, a parameter of the newly constructed initial object model is identified. A simple object model is constructed by simplifying, through a mathematical process, the newly constructed initial object model in which the identified parameter is applied. A plant model can be newly constructed by connecting the newly constructed simple object model to other simple object models by the existing connection lines that correspond to the pre-replacement modeling object. That is, a plant model can be newly constructed by replacing the existing simple object model of the pre-replacement modeling object with the newly constructed simple object model. Therefore, according to this apparatus, a plant model is not newly constructing by modifying the whole plant model, but merely the initial object model that corresponds to an existing simple object model that is a portion of the plant model is modified. From the modified initial object model, a simple object model is constructed. A plant model can be newly constructed by replacing an existing simple object model that is a portion of the plant model with a newly constructed simple object model. Therefore, a plant model can be newly constructed with a small amount of labor.

Incidentally, as described above, the newly constructed initial object model and the newly constructed simple object are associated with their corresponding existing GUI element, and are thus stored in the memory.

Besides, in the model construction apparatus of the embodiment, in the case where a new modeling object is added to a plant and the plant includes a modeling object that has substantially the same characteristic as the added modeling object (hereinafter, referred to as “added modeling object”), the initial object model of the modeling object that has substantially the same characteristic as the added modeling object can be specifically determined via the GUI element that corresponds to the modeling object that has substantially the same characteristic as the added modeling object. Therefore, when a plant model is to be newly constructed by the model construction apparatus of this embodiment in the case where a new modeling object is added to the existing plant model and the existing plant model includes a modeling object That has substantially the same characteristic as the added modeling object, the initial object model of the modeling object that has substantially the same characteristic as the added modeling object is invoked (or reproduced) via the GUI element that corresponds to the modeling object that has substantially the same characteristic as the added modeling object. By modifying the invoked initial object model, an initial object model of the added modeling object is newly constructed. Then, a parameter of the newly constructed initial object model is identified. A simple object model is constructed by simplifying, through a mathematical process, the newly constructed initial object model in which the identified parameter has been applied. A plant model can be newly constructed by connecting the newly constructed simple object model to related existing simple object models by new connection lines so that the conserved quantity output from the newly constructed simple object model can be sent to the related simple object models. That is, a plant model can be newly constructed by adding the simple object model of an added modeling object to the existing plant model. Therefore, a plant model can be newly constructed with a small amount of labor.

Incidentally, in the model construction apparatus of this embodiment, a GUI element that corresponds to a newly constructed initial object model and to a newly constructed simple object model is newly constructed, and the newly constructed initial object model and the newly constructed simple object model are associated with the newly constructed GUI element and are stored in the memory.

Besides, when a plant model is newly constructed by the model construction apparatus of this embodiment in the case where a new modeling object is added to a plant and the plant does not include a model object that has substantially the same characteristic as the added modeling object (that is, the added modeling object), an initial object model of the added modeling object is newly constructed. Then, a parameter of the newly construction initial object model is identified. Then, a simple object model is constructed by simplifying, through a mathematical process, the newly constructed initial object model to which the identified parameter has been applied. A plant model can be newly constructed by connecting the newly constructed simple object model to existing simple object models by new connection lines so that the conserved quantity output from the newly constructed simple object model can be sent to related simple object models. That is, a plant model can be newly constructed by adding the simple object model of an added modeling object to the plant model. Therefore, a plant model can be newly constructed with a small amount of labor.

Incidentally, in the model construction apparatus of this embodiment, a GUI element that corresponds to the newly constructed initial object model and the newly constructed simple object model is newly constructed as described above, and the newly constructed initial object model and simple object model are associated with the newly constructed GUI element, and are thus stored in the memory.

Besides, in the case where a modeling object is replaced with a new modeling object and the characteristic of the post-replacement modeling object is not substantially the same as that of the pre-replacement modeling object, but is completely different therefrom, it is appropriate that a plant model is newly constructed by the same procedure as that described for the case where a new modeling object is added to a plant and the plant does not include a modeling object that has substantially the same characteristic as the added modeling object.

Thus, in the model construction apparatus of this embodiment, when there arises a need to newly construct a plant model, a plant model can be newly constructed by constructing a new object model through the use of an object model that constitutes a portion of the existing plant model and adding the newly constructed object model to the plant model. Besides, by newly constructing another object model and adding the newly constructed object model to the plant model, a new plant model can be constructed. Therefore, according to the model construction apparatus of this embodiment, a plant model that is very high in general-purpose characteristic or versatility (i.e., that is standardized) can be constructed without dependency on the methods of expression (or methods of description) of the individual object models.

Incidentally, if a parameter for an initial object model of a specific modeling object (i.e., a modeling object whose characteristic has changed, a post-replacement modeling object, or an added modeling object) is able to he identified appropriately when such a parameter needs to be identified in order to newly construct a simple object model of the specific modeling object, a parameter in the initial object model of the specific modeling object may be identified on the basis of only the actual conserved quantity of the specific modeling object that is given when a specific quantity of manipulation is input to the specific modeling object.

Besides, in the case where when a simple object model of a specific modeling object (i.e., a modeling object whose characteristic has changed, a post-replacement modeling object, or an added modeling object) is to be constructed, there is a need to newly construct a simple object model of a modeling object other than the specific modeling object, it is appropriate to newly construct the simple object model of the modeling object other than the specific modeling object in a manner as described below.

That is, in the model construction apparatus of this embodiment, it is appropriate to construct a simple object model by invoking (or reproducing) the initial object model of the specific modeling object via the GUI element that corresponds to the specific modeling object, and newly constructing an initial object model of the specific modeling object through modification of the invoked initial object model, and by identifying a parameter of the newly constructed initial object model, and then by simplifying, through a mathematical process, the newly constructed initial object model in which the identified parameter has been applied.

Of course, in this case, the model construction apparatus of this embodiment newly constructs a plant model by connecting the newly constructed simple object model to other simple object models by the existing connection lines that correspond to the specific modeling object. Besides, the initial object model and the simple object model that are newly constructed in the present operation are stored and associated with their corresponding existing GUI element in the memory.

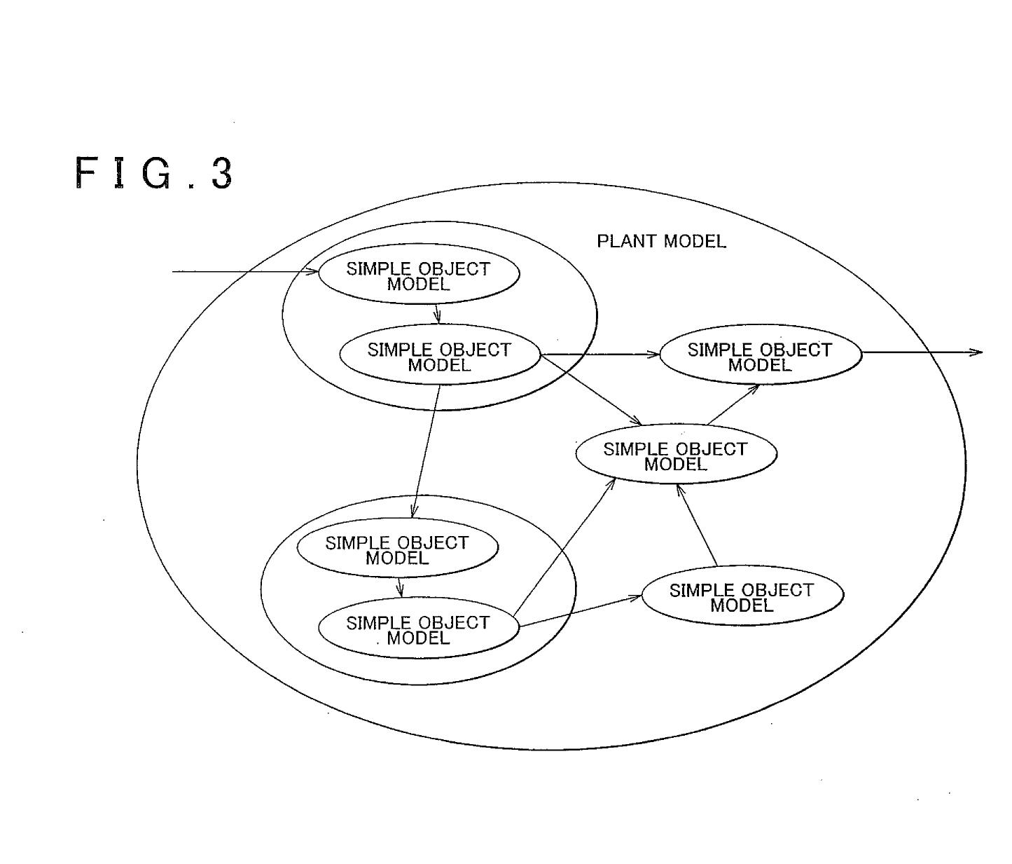

Incidentally, the foregoing model construction apparatus of the embodiment may also have a function of storing and associating a unit of a plurality of object models with other units of object models or with other object models according to need, as shown in FIG. 3.

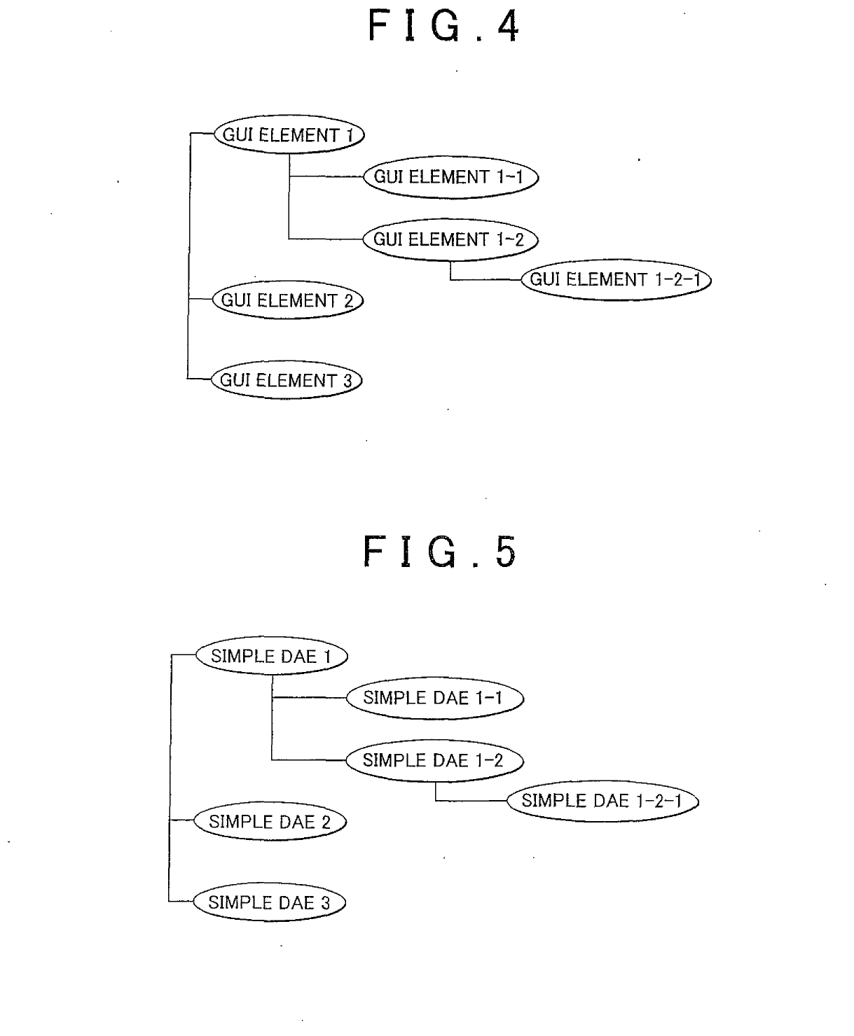

Besides, the foregoing model construction apparatus of the embodiment has a function in which, for example, as shown in FIG. 4, when three GUI elements 1 to 3, two GUI elements 1-1 and 102 related to the GUI element 1, and a GUI element 1-2-1 related to the GUI element 1-2 are constructed, these GUI elements are associated with each other in a tree structure and are thus stored in the memory. Then, the foregoing model construction apparatus of the embodiment has a function of, as shown in FIG. 5, associating simple differential algebraic equations 1 to 3, 1-1, 1-2, 1-2-1 that correspond to the individual GUI elements with each other and storing in the memory by following the tree structure of the GUI elements.

Besides, in the foregoing embodiment, in the case where a simple object model is newly constructed and the newly constructed simple object model is connected to existing simple object models by existing connection lines, it is permissible to modify existing connection lines or construct new connection lines according to need.

Besides, the model construction apparatus of the embodiment is able to newly construct a plant model with a small amount of labor even in the case where a need to newly construct a plant model arises due to deletion of a modeling object. In that case, the model construction apparatus of the embodiment invokes the simple object model that corresponds to the deleted modeling object via the GUI element that corresponds to the deleted modeling object, and deletes the invoked simple object model, and modifies the construction of existing connection lines according to need.

1. A model construction apparatus which constructs a model of a plant that includes a plurality of modeling objects as a plant model, and which has a graphical user interface, the model construction apparatus comprising:
a function of constructing models of the modeling objects separately for each modeling object as object models;
a function of constructing the plant model by connecting the object models with each other by connection lines so that conserved quantities output from the object models are able to be exchanged between related object models that are included among the object models;
a function of constructing elements that correspond to the object models as modeling object elements on the graphical user interface; and
a function of storing the object models while associating the object models with the respective modeling object elements corresponding to the object models so that the object models are able to be invoked via the modeling object elements.

2. The model construction apparatus according to claim 1, further comprising a function of utilizing as an object model a model of a modeling object that is derived from a differential algebraic equation that is based on a physical law if the plant is capable of being expressed by a plurality of physical laws.

3. The model construction apparatus according to claim 2, further comprising:
a function of utilizing as an initial object model the model of the modeling object that is derived from the differential algebraic equation based on the physical law;
a function of constructing a simple object model by simplifying the initial object model; and
a function of utilizing the simple object model as the object model.

4. A model construction method of constructing a model of a plant that includes a plurality of modeling objects as a plant model, the method comprising:
constructing models of the modeling objects separately for each modeling object as object models;
constructing the plant model by connecting the object models by connection lines so that conserved quantities output from the object models are able to be exchanged between related object models;
constructing elements that correspond to the object models as modeling object elements on the graphical user interface; and
storing the object models while associating the object models with the respective modeling object elements corresponding to the object models so that the object models are able to be invoked via the modeling object elements.

5. The model construction method according to claim 4, wherein if the plant is capable of being expressed by a plurality of physical laws, a model of a modeling object that is derived from a differential algebraic equation that is based on a physical law is utilized as an object model.

6. The model construction method according to claim 5, wherein:
a model of the modeling object that is derived from a differential algebraic equation based on a physical law is utilized as an initial object model;
a simple object model is constructed by simplifying the initial object model; and
the simple object model is utilized as the object model.

7. The model construction method according to claim 4 or 5, wherein
the model construction method performs at least one of processes (A) to (D):
(A) when there arises a need to newly construct the plant model because a characteristic of a modeling object has changed,
the object model that corresponds to the modeling object whose characteristic has changed is invoked via a modeling object element that corresponds to the modeling object whose characteristic has changed, and
the object model of the modeling object whose characteristic has changed is newly constructed by utilizing the invoked object model, and
the plant model is constructed by connecting the newly constructed object model to other existing object models by existing connection lines that correspond to the modeling object whose characteristic has changed, and
the newly constructed object model is stored and associated with an existing modeling object element that corresponds to the modeling object whose characteristic has changed;
(B) when there arises a need to newly construct the plant model because a modeling object is replaced with another modeling object,
the object model that corresponds to a pre-replacement modeling object is invoked via the modeling object element that corresponds to the pre-replacement modeling object, and
the object model of a post-replacement modeling object is newly constructed by utilizing the invoked object model, and
the plant model is constructed by connecting the newly constructed object model to other existing object models by existing connection lines that correspond to the pre-replacement modeling object, and
the newly constructed object model is stored and associated with the existing modeling object element that corresponds to the pre-replacement modeling object;
(C) when there arises a need to newly construct the plant model because a new modeling object having substantially same characteristic as an existing modeling object is added to plant,
the object model of an existing modeling object that has substantially same characteristic as the added, new modeling object is invoked via the modeling object element that corresponds to the existing modeling object that has substantially same characteristic as the added new modeling object, and
the object model of the added new modeling object is newly constructed by utilizing the invoked object model, and
the plant model is constructed by connecting the newly constructed object model to a related existing object model by a new connection line so that the conserved quantity output from the newly constructed object model is able to be sent to the related existing object model, and
the modeling object element that corresponds to the newly constructed object model is newly constructed on the graphical user interface, and
the newly constructed object model is stored and associated with the newly constructed modeling object element so that the newly constructed object model is able to be invoked via the newly constructed modeling object element; and
(D) when there arises a need to newly construct the plant model because a new modeling object that has a characteristic different from the characteristic of an existing modeling object is added to the plant,
the object model of the added new modeling object is newly constructed, and
the plant model is constructed by connecting the newly constructed object model to a related existing object model by a new connection line so that the conserved quantity output from the newly constructed object model is able to be sent to the related existing object model, and
the modeling object element that corresponds to the newly constructed object model is newly constructed on the graphical user interface, and
the newly constructed object model is stored and associated with the newly constructed modeling object element so that the newly constructed object model is able to be invoked via the newly constructed modeling object element.

8. The model construction method according to claim 6,
wherein initial object models that correspond to the object models are stored and associated with respective modeling object elements that correspond to the object models that correspond to the initial object models so that the initial object models are able to be invoked via the respective modeling object elements that correspond to the object models, and
wherein the model construction method performs at least one of processes (A) to (D):
(A) when there arises a need to newly construct the plant model because a characteristic of a modeling object has changed,
the initial object model that corresponds to the modeling object whose characteristic has changed is invoked via a modeling object element that corresponds to the modeling object whose characteristic has changed, and
the initial object model of the modeling object whose characteristic has changed is newly constructed by utilizing the invoked initial object model, and the simple object model is newly constructed by simplifying the newly constructed initial object model, and
the plant model is constructed by connecting the newly constructed simple object model to other existing simple object models by existing connection lines that correspond to the modeling object whose characteristic has changed, and
the newly constructed initial object model is stored and associated with an existing modeling object element that corresponds to the modeling object whose characteristic has changed;
(B) when there arises a need to newly construct the plant model because a modeling object is replaced with another modeling object,
the initial object model that corresponds to a pre-replacement modeling object is invoked via the modeling object element that corresponds to the pre-replacement modeling object, and
the initial object model of a post-replacement modeling object is newly constructed by utilizing the invoked initial object model, and
the simple object model is newly constructed by simplifying the newly constructed initial object model,
the plant model is constructed by connecting the newly constructed simple object model to at least one other existing simple object model by an existing connection line that corresponds to the pre-replacement modeling object, and
the newly constructed initial object model is stored and associated with the existing modeling object element that corresponds to the pre-replacement modeling object;
(C) when there arises a need to newly construct the plant model because a new modeling object that has substantially same characteristic as an existing modeling object is added to the plant,
the initial object model of an existing modeling object that has substantially same characteristic as the added new modeling object is invoked via the modeling object element that corresponds to the existing modeling object that has substantially same characteristic as the added new/modeling object, and
the initial object model of the added new modeling object is newly constructed by utilizing the invoked initial object mode, and
the simple object model is newly constructed by simplifying the newly constructed initial object model, and
the plant model is constructed by connecting the newly constructed simple object model to a related existing simple object model by a new connection line so that the conserved quantity output from the newly constructed simple object model is able to be sent to the related existing simple object model, and
the modeling object element that corresponds to the newly constructed initial object model is newly constructed on the graphical user interface, and
the newly constructed initial object model is stored and associated with the newly constructed modeling object element so that the newly constructed initial object model is able to be invoked via the newly constructed modeling object element; and
(D) when there arises a need to newly construct the plant model because a new modeling object that has a characteristic different from the characteristic of an existing modeling object is added to the plant,
the simple object model is newly constructed by newly constructing the initial object model of the added new modeling object and by simplifying the newly constructed initial object model, and
the plant model is constructed by connecting the newly constructed simple object model to a related existing simple object model by a new connection line so that the conserved quantity output from the newly constructed simple object model is able to be sent to the related existing simple object model, and
the modeling object element that corresponds to the newly constructed initial object model is newly constructed on the graphical user interface, and
the newly constructed initial object model is stored and associated with the newly constructed modeling object element so that the newly constructed initial object model is able to be invoked via the newly constructed modeling object element.

9. A model construction apparatus which constructs a model of a plant that includes a plurality of modeling objects as a plant model, comprising:
a graphical user interface; and:
a storage device that:
stores models of the modeling objects separately for each modeling object as object models;
stores the plant model that is constructed by connecting the object models with each other by connection lines so that conserved quantities output from the object models are able to be exchanged between related object models that are included among the object models;
stores elements that correspond to the object models as modeling object elements on the graphical user interface; and
stores the object models while associating the object models with the respective modeling object elements corresponding to the object models so that the object models are able to be invoked via the modeling object elements.

10. The model construction apparatus according to claim 9, wherein:
the storage devices stores as an object model a model of the modeling object that is derived from a differential algebraic equation based on a physical law if the plant is capable of being expressed by a plurality of physical laws.

11. The model construction apparatus according to claim 10, wherein
the storage device stores as an initial object model the model of the modeling object that is derived from the differential algebraic equation based on the physical law;
stores a simple object model that is constructed by simplifying the initial object model; and
stores the simple object model as the object model.
